(19) United States
(12) Patent Application Publication
(10) Pub. No.: US 2005/0029254 A1
(43) Pub. Date: Feb. 10, 2005

(54) Microwave reflecting container

(75) Inventors: Bruce Robbins, Richmond, VA (US); Timothy Bohrer, Chicago, IL (US)

Correspondence Address: David C. Jenkins;Eckert Seamans Cherin & Mellott, LLC, 44th Floor, 600 Grant Street, Pittsburgh, PA, 15219, US

(73) Assignee: Reynolds Food Packaging, Richmond, VA (US)

(21) Appl. No.: 10/889,678

(22) Filed: Jul. 13, 2004

Related U.S. Application Data
(60) Provisional application No. 60/486,939, filed on Jul. 14, 2003.

(51) Int. Cl. H05B 6/80

(52) U.S. Cl. 219/729; 219/725

(57) ABSTRACT

A container formed of a microwave reflecting material and intended to hold its contents, in a thermally neutral environment, when placed within a microwave oven interior, and such as within a larger sized food tray container holding other microwave-heatable items. The container includes a main body and a sealable lid, both of which are constructed of the microwave reflecting material. The lid may also include a paper layer along its exterior surface, for both strength and decorating purposes. Arcing in the microwave would be controlled by not having any sharp edges on the container.

### CROSS REFERENCE TO RELATED APPLICATION

This application claims priority under 35 U.S.C. § 119(e) to U.S. Provisional Patent Application Ser. No. 60/486,939, filed Jul. 14, 2003, entitled MICROWAVE KEEP COOL CONTAINER.

### FIELD OF THE INVENTION

The present invention relates generally to containers capable of being placed within a microwave oven. More specifically, the present invention discloses a container, such as one provided as an inserted component of a larger microwaveable food tray, structured to reflect microwaves so that substances within the container are not heated by irradiation. The container is constructed of a microwave reflecting material in order to maintain its contents of the container in a thermally neutral (non-heated) environment while the remaining contents of the food tray are heated by microwave action.

### BACKGROUND OF THE INVENTION

As is known in the art, certain food items, such as, but not limited to, chicken nuggets or breaded cheese sticks, are typically sold in microwaveable packaging structured to be heated by irradiation in a microwave oven. The food trays typically have a plastic film covering the food items. This film is structured to prevent moisture and heat in the form of steam from escaping. These packages, or “food trays,” may further include a smaller container for a condiment, such as a dipping sauce. The container typically includes a peel-off top that is well-known to consumers. It has been found undesirable that the dipping sauce (meant to be maintained in a cool condition) be placed in the microwave oven at the same time as the food, and which is thereby then heated along with the other food items. Thus, to avoid heating the substance in the container, the user is required to open the food tray to remove the container. The removal of the film, however, disturbed the steam-retaining function of the plastic film. To avoid this situation, food trays needed to be constructed in such a way as to allow for the removal of the container. Such a construction added to the cost of the packaging and was inconvenient to users who preferred to simply place the food tray in the microwave oven.

There is, therefore, a need for a container that may be placed in a microwave oven, but which is structured to reflect microwave radiation.

There is a further need for a container that may be placed in a microwave oven structured to keep the contents thereof cool and which is in a design well-knownto consumers.

### SUMMARY OF THE INVENTION

These needs, and others, are met by the present invention which provides a container formed of a microwave reflecting material. The container is intended to hold an edible food item, and is structured to be placed within a microwave oven along with other microwave-heatable items. The container includes a main body and a sealable lid, both of which are constructed of the microwave reflecting material.

In a preferred embodiment, the container is constructed of an aluminum material with a heat sealing coating along an interior surface. The heat-sealing coating is also typically formed into a top flange associated with the body and the lid is constructed of a suitable laminate and a heat seal layer to seal the container. It is also contemplated that the lid may include a paper layer along its exterior surface, for both strength and decorating purposes. Arcing in the microwave would be controlled by not having any sharp edges on the container.

### BRIEF DESCRIPTION OF THE DRAWINGS

Reference will now be made to the attached drawings, when read on combination with the following detailed description, wherein like reference numerals refer to like parts throughout the several views, and in which:

FIG. 1 is an environmental view of the microwave keep cool container positioned within a larger sized and microwaveable food tray;

FIG. 2 is a perspective and assembled view of the container illustrated in FIG. 1;

FIG. 3 is an illustration in perspective of the main body of the container;

FIG. 4 is a cutaway view taken along line 4-4 of FIG. 3 and illustrating the multi-layering configuration of the container body, and such as prior to it being formed into a desired three-dimensional shape;

FIG. 5 is a top view of the assembleable lid of the microwave keep cool container; and

FIG. 6 is a cutaway view taken alone line 6-6 of FIG. 5 and illustrating an enlarged cross section of the lid.

### DETAILED DESCRIPTION OF PREFERRED EMBODIMENTS

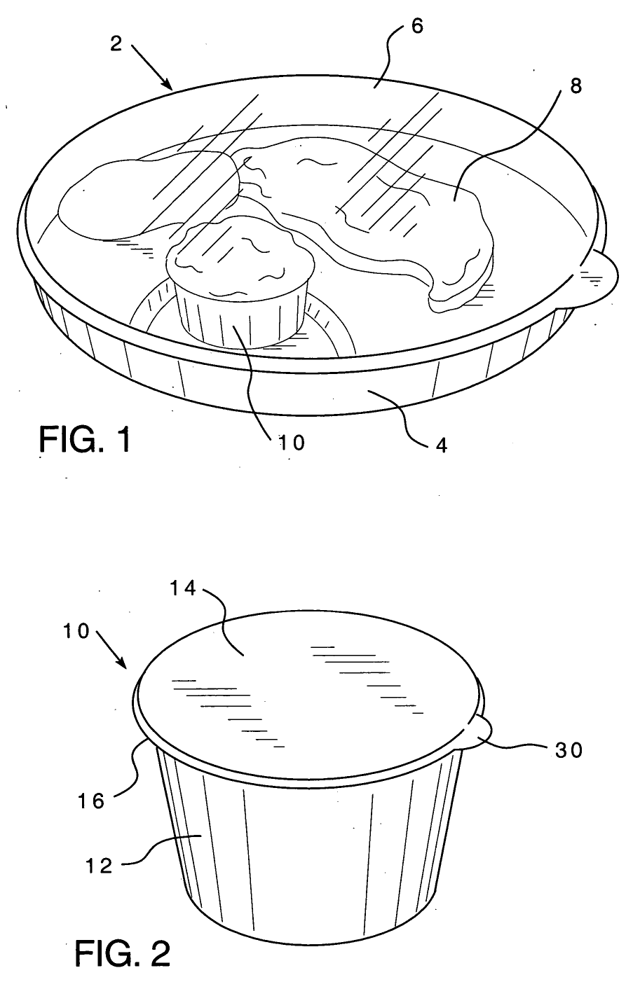

Referring now to FIG. 1, an environmental view of the microwave resistant container is illustrated 10, positioned within a larger sized and microwaveable food tray 2. The food tray 2 includes a base 4 and a top 6. The base 4 and the top 6 are removably engaged to each other and when coupled form an enclosed compartment 7. The compartment 7 is structured to contain items 8 which are, typically, edible. The container 10 of the present invention functions as a microwave keep cool container structured to maintain, in non-irradiated fashion, the contents of the container 10. The content of the container 10 is, typically, a condiment such as, but not limited to, a dipping sauce. In a preferred embodiment, the food tray 2 includes a separating structure 9, such as, but not limited to, a ridge on the base 4, designed to maintain the items 8 physically separated from the container 10 to reduce heat transfer via conduction. That is, during and after heating of the food tray 2 in a microwave oven, the separating structure 9 acts as a barrier around the container 10 to keep the hot food items 8 away from the container.

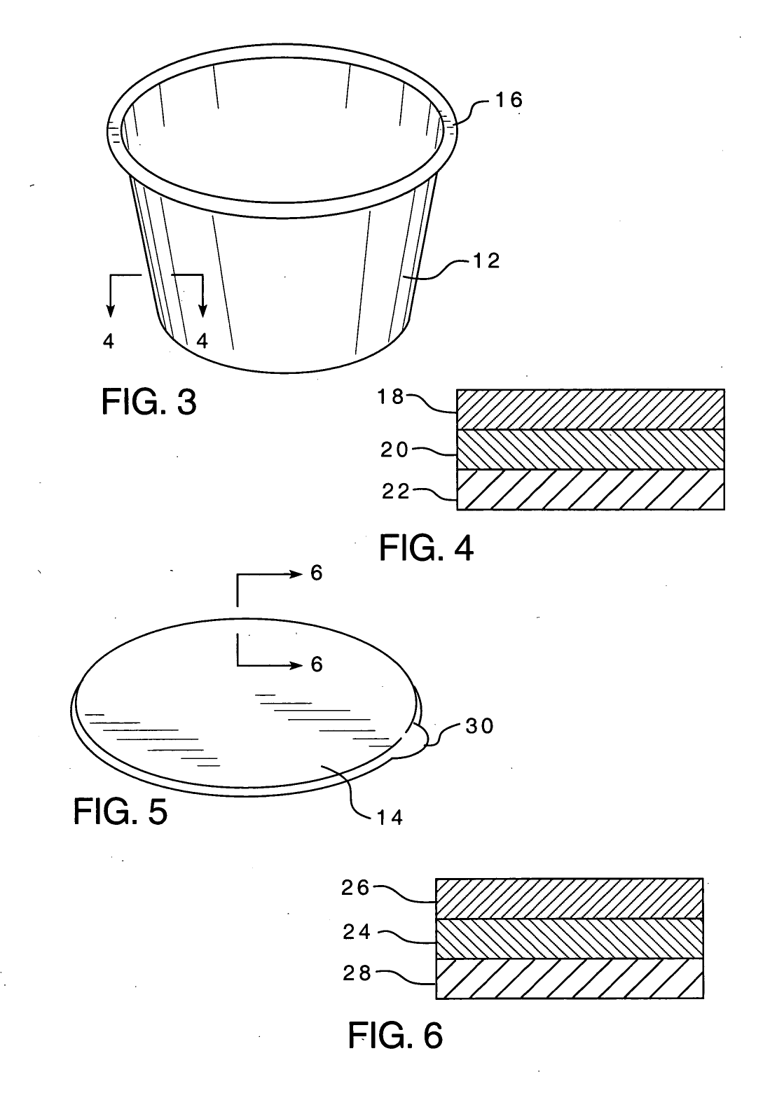

Referring now to FIG. 2, the container 10 includes a main body 12 and a sealable lid 14. Referring further to the perspective illustration of the main body 12 in FIG. 3, as well as the multi-layered cutaway view of FIG. 4, both the body 12 and lid 14 are constructed of a microwave reflecting material. The container body 12 defines an enclosed space with an opening and is, preferably, shaped as a cup. However, other shapes may also be used. Thus, the body 12, preferably, includes a base 11 and a depending sidewall 13. The base 11 is preferably circular and the sidewall 13 is a tapered cylinder. As best again shown in FIG. 3, a top flange 16 extends around an upper periphery of the sidewall 13. The flange 16 is structured to be coupled to the sealable lid 14.

In a preferred embodiment, the container 10 is constructed of an aluminum material with a heat sealing coating along an interior surface. As best illustrated in the cutaway view of FIG. 4, the container body 12 includes a plurality of layers, including an inner-most heat sealable layer 18, an intermediate microwave reflecting layer 20, and an optional exterior coating 22, these typically being adhesively secured together. The heat-sealing coating is also typically formed into the top flange 16. The container 10 is structured without sharp edges to reduce the incidence of arcing within the microwave oven during heating. The multi-layered material of which the container 10 is constructed is capable of being initially provided in a substantially flattened, or sheet-like, or blank-like, form and which is then subsequently formed into a desirable three-dimensional shape, such as through stamping or other conventional manufacturing process.

Referring to FIG. 5, the lid 14 is again illustrated and is likewise constructed of a suitable laminate of relecting layer 24, on a top side of which is further provided a paper layer 26 (providing both strength and decorative characteristics) and on an opposing bottom side (facing the open interior of the container and again typically secured in adhesive fashion) a heat seal layer 28 to thermally seal the contents of the container 10. The lid 14 is structured to engage the top flange 16 of the main container body 12. An arcuately contoured gripping portion 30 is further located along a peripheral edge location of the lid 14, as best again shown in FIG. 5. The lid 14 may include an angled lip edge that extends over an outer edge wall of the associated top flange 16. The lip edge may be folded over the flange 16 in order to secure the lid 14 over the body 12. In this configuration, the container 10 substantially resists the penetration of microwaves into the interior of the container 10. Thus, a material disposed within the container 10 is generally not subjected to microwave radiation when the container 10, as part of a larger food tray 2, is placed in a microwave oven.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of invention which is to be given the full breadth of the claims appended and any and all equivalents thereof.

1. A container structured to be placed within a microwave oven and for maintaining contents placed within the container in a thermally insulating fashion in response to microwave irradiation, said container comprising:
a body defining a space and having an opening, said body including at least a heat sealable layer and a microwave reflecting layer; and
a lid sealingly engaged over said opening, said lid including a microwave reflecting layer and a bottom facing heat sealable layer in contact with said container body.

2. The container as described in claim 1, said body further comprising an exterior coating layer.

3. The container as described in claim 2, said lid further comprising a top facing paper layer.

4. The container as described in claim 3 wherein said body is cup shaped having a base and a depending sidewall.

5. The container as described in claim 4 wherein
said sidewall includes a top flange; and
said lid is structured to sealingly engage said top flange.

6. The container as described in claim 5, said lid further comprising a contoured gripping portion located along a peripheral edge location of said lid.

7. The container as described in claim 1, said lid further comprising a top facing paper layer.

8. The container as described in claim 1, said lid further comprising a contoured gripping portion located along a peripheral edge location of said lid.

9. The container as described in claim 1 wherein said body is cup shaped having a base and a depending sidewall.

10. The container as described in claim 9 wherein
said sidewall includes a top flange; and
said lid is structured to sealingly engage said top flange.

11. The container as described in claim 1, said main body having a specified shape and size and being initially configured in multiple layers and in a flat, sheet-like manner.

12. The container as described in claim 1, wherein said body reflecting layer and said lid reflecting layer are constructed of aluminum.

13. A food tray structured to be heated in a microwave oven, said food tray comprising:
a base;
a top structured to removably engage said base and being coupled to said base forming a compartment; and
a container disposed in said compartment, said container structured to resist the penetration of microwaves.

14. The food tray as described in claim 13, wherein said container comprises:
a body defining a space and having an opening, said body including at least a heat sealable layer and a microwave reflecting layer; and
a lid sealingly engaged over said opening, said lid including a microwave reflecting layer and a bottom facing heat sealable layer in contact with said container body.

15. The food tray as described in claim 13, said body further comprising an exterior coating layer.

16. The food tray as described in claim 13, said lid further comprising a top facing paper layer.

17. The food tray as described in claim 13 wherein said body is cup shaped having a base and a depending sidewall.

18. The food tray as described in claim 17 wherein
said sidewall includes a top flange; and
said lid is sealingly engaged to said top flange.

19. The food tray as described in claim 13, said lid further comprising a contoured gripping portion located along a peripheral edge location of said lid.

20. The food tray as described in claim 13, wherein said base includes a separating structure that acts a barrier around said container.
